(19) United States
(12) Patent Application Publication
(10) Pub. No.: US 2008/0070550 A1
(43) Pub. Date: Mar. 20, 2008

(54) Providing Subscriber Specific Information Across Wireless Networks

(76) Inventor: David Alan Hose, Boulder, CO (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/857,173

(22) Filed: Sep. 18, 2007

Related U.S. Application Data
(60) Provisional application No. 60/826,334, filed on Sep. 20, 2006.

(51) Int. Cl. H04M 1/66; H04Q 7/20

(52) U.S. Cl. 455/411; 455/433

(57) ABSTRACT

A Clearinghouse is configured to provision subscriber-specific information with respect to subscribers of multiple wireless networks associated with multiple carriers. Application providers can access subscriber-specific information for subscribers of the various networks via a single source, thereby expediting application development and deployment. Moreover, the reach of such wireless service applications can be extended across wireless networks, thereby enhancing application functionality for subscribers. The Clearinghouse can provision the subscriber-specific information in accordance with specific rule sets for each carrier and/or application provider, thereby enabling provision of subscriber-specific information across multiple networks while addressing the privacy and other concerns of individual carriers. For example, in the context of a social networking application, a social network need not be limited in relation to carrier affiliations.

### CROSS REFERENCE

The present application claims the benefit of U.S. Provisional Application No. 60/826,334, filed Sep. 20, 2006, entitled “Providing Subscriber-Specific Information Across Wireless Networks,” which is hereby incorporated by reference in its entirety.

### TECHNICAL FIELD

The subject matter described herein relates to methods and systems for determining the location of a wireless network access device (e.g., cell phone, mobile computer or hand-held device configured for wireless communications, etc.) and then supplying services based on the location to the device user or other parties. More particularly, the subject matter of this application relates to a Clearinghouse for aggregating mobile device location information from multiple, independent sources, and providing such information to various applications and users while enabling the subjects of such information to control various aspects of the information, including, for example, opt-ins, opt-outs, notifications, memberships, and the like.

### BACKGROUND

Wireless carriers are increasingly enhancing their services and generating revenues by providing services to subscribers beyond traditional wireless telephony services. Many of the services that are currently experiencing rapid growth involve applications that utilize dynamic, or changing, subscriber-specific information. Examples of such applications and of different types of subscriber-specific information include (but are by no means limited to) the following:
Location-Based Service (LBS) applications that use the subscriber's current location to provide location targeted information and/or services;
presence applications that use information regarding the presence, absence or other state of the subscriber in relation to the network; and
availability applications that use information concerning whether a subscriber is available, and on what device, for specified purposes.

Attempts to aggregate user profile information have been known. For example, a telecommunications-based initiative known as 3GPP Generic User Profile (GUP) aims to aggregate user profile information relevant to network operators. The Third Generation Partnership Project (3GPP) (see http://www.3gpp.org) is a standards developing organization for 3G telephone services. The idea behind GUP is that things like cell phone address books, IM contacts, Web page favorites, etc. can be stored in one or more servers, and all devices a user owns could then be configured to use GUP to access this “profile” information via GUP. It has been described as a kind of LDAP (Lightweight Directory Access Protocol) for cell phones and other wireless devices.

The GSM Home Subscriber Server (HSS), or User Profile Server Function (UPSF), is the master user database that supports the IMS network entities actually handling the calls/sessions. Similar to the GSM Home Location Register (HLR), the HSS contains subscription-related information (including the IMPU, IMPI, IMSI, and MSISDN), performs authentication and authorization of the user, and can provide information about the physical location of the user. Other industry initiatives for user profile aggregation include the “Passport” system and the Liberty Alliance's open standard for federated network identity.

While HLRs coupled with Intelligent Networks and service control platforms enabled the mobility of services both inside and outside the home network, access to subscribed services were and are still quite restricted outside the subscriber's home network. The GUP and HSS concepts seek to improve the current state of affairs by enabling home network services to be available in visited networks. However, a shortcoming of the GUP, HLR, and HSS is that they do not provide complete accommodation for user preferences, privacy, or context sensitive services from providers outside the home network operator. One goal of the present invention is to provide a framework where these controls operate and also bridge the dissimilar standards, services, and networks as standardized, for example, by 3GPP, 3GPP2, IEEE, and the IEFT.

The case of LBS applications is illustrative. These applications generally provide location information for participating subscribers and may process the raw location information relative to defined location zones or boundaries. Among the businesses or applications that may wish to use such location information are advertisers, social networks, content providers, enterprises and game developers. Thus, advertisers may target promotions, coupons or messages to subscribers proximate to a business outlet. Subscribers of social networks may be enabled to connect to nearby people. News, weather, traffic or other content providers may target content based on a location or proximity. Companies or other enterprises can increase efficiency based on knowledge of supply chain and field staff locations. Similarly, game developers can achieve a greater level of interactivity by taking advantage of knowing current player locations. It will be appreciated that many other business types and applications may benefit from accessing subscriber location information and this represents an important opportunity for wireless carriers.

While applications that use subscriber-specific information thus represent an important opportunity for wireless carriers and their partners, it has been recognized that significant obstacles remain with respect to realizing this opportunity. Many of these obstacles relate to fragmentation of the wireless market and the associated proliferation of protocols, policies, application providers, data formats and content, and the like. These factors can overwhelm wireless carriers and partners who might otherwise have an interest in pursuing this opportunity.

In the case of LBS service applications, location information may be received from a variety of different types of Position Determining Equipment (PDE) having different underlying technologies, such as: GPS (Global Positioning System); angle of arrival (AOA); time difference of arrival (TDOA); cell, cell sector and micro-cell; etc. Some of these are dependent on network topology, which may vary across networks. Different applications may have different needs regarding location information relating to, for example, timelines, accuracy, and cost. Moreover, many applications involve processing raw location information in relation to neighborhood or campus boundaries, proximity to a specified address, etc., thus requiring correlation to mapping data. In addition, privacy considerations concerning the use of location information may be impacted by regulations, policies and contracts that vary from carrier to carrier, location to location and, sometimes, even subscriber to subscriber.

Due in part to these complications, location information has generally been separately provisioned for each wireless network. As a result, content providers have had to develop or adapt applications for each supported carrier and the reach of each such application has been limited to subscribers of the corresponding network. This is inefficient for carriers and application providers and will become increasingly unacceptable to application users, and limits revenues derived in connection with such applications. For example, subscribers to a social networking application involving a buddy list may object to having their social network limited based on carrier affiliation. Similarly, advertisers who might otherwise be interested in targeting ads to wireless subscribers within a given vicinity may be discouraged due to the need to contract with multiple carriers, define the targeted geographic zone in relation to multiple networks, etc. Thus, the problems associated with addressing these difficulties are significant.

### SUMMARY

The present invention provides a Clearinghouse for provisioning subscriber-specific information with respect to subscribers of multiple wireless networks associated with multiple carriers. In this manner, application providers can access subscriber specific information for subscribers of the various networks via a single source, thereby expediting application development and deployment. Moreover, the reach of such wireless service applications can be extended across wireless networks thereby enhancing application functionality for subscribers and potentially enhancing revenue possibilities for carriers. The Clearinghouse can provision the subscriber-specific information in accordance with specific rule sets for each carrier and/or application provider, thereby enabling provision of subscriber-specific information across multiple networks while addressing the privacy and other concerns of individual carriers. In this manner, new applications and functionality can be deployed that might otherwise be inhibited by practical considerations.

In accordance with one aspect of the present invention, a method and apparatus (“utility”) are (is) provided for provisioning subscriber-specific information of subscribers in different networks to a wireless service application. The utility involves establishing a platform for provisioning subscriber-specific information. The platform receives first subscriber-specific information regarding a first subscriber of a first wireless network and second subscriber information regarding a second wireless subscriber of a second wireless network. The platform is operative to provide the first and second subscriber-specific information to a wireless service application. In this manner, subscribers can port information across multiple networks as may be desired. For example, in the context of a social networking application, a social network need not be limited in relation to carrier affiliations.

In accordance with another aspect of the present invention, a utility is provided for allowing a wireless service application using subscriber-specific information to reach subscribers of different wireless networks. The utility involves receiving, at a network platform, first and second information from a wireless service application, where the first information is directed to a first subscriber of a first wireless network and the second recognize, based on such a recent request, that updating of subscriber-specific information for a particular subscriber in response to a specific request is unnecessary. Accordingly, the platform can enhance functionality and efficiency in a variety of ways. Additional details and advantages of the invention are set forth below.

As explained in great detail below, an illustrative implementation of the inventive subject matter disclosed herein provides subscribers the means and methods to control their privacy settings, multimedia preferences, permissions and identity, pseudonyms and subscriptions regardless of the type of radio or wireline access network employed. Various services are enabled by the tools, interfaces and storage provided via a clearinghouse in accordance with the present invention. Such services may include the provision of information concerning a wireless device user's availability, location, presence and call-handling preferences. The clearinghouse may also be used to control opt-ins, opt-outs, notifications and memberships. Such memberships may include business contacts, buddies, ad hoc groups or pre-set static groups.

The use of the inventive clearinghouse also allows enforcement of outside controls on the use or transmission of subscriber-related data. These controls include both internal and external auditing of security and procedures. The necessary agreements between the various operators and wireless operators will provide for legal clarifications that clearly spell out data and user protections, providing a legal framework upon which subscribers may rely. This combination of internal, external and legal controls all serve to comfort the user via the clearinghouse as a single trusted point of contact for subscribers and a single source provider of security, privacy and services.

Other aspects of the disclosed subject matter are described below.

### BRIEF DESCRIPTION OF THE DRAWINGS

The foregoing summary as well as the following detailed description are better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 schematically depicts an illustrative embodiment of the present invention, including components, interfaces, and external dependencies.

FIG. 2 schematically depicts an illustrative embodiment of a clearinghouse in accordance with the present invention.

FIG. 3A shows exemplary clearinghouse interconnections to a GSM carrier, where the clearinghouse acts as a 3GPP defined Gateway Mobile Location Center (GMLC) and LCS Client in multiple wireless networks.

FIG. 3B shows exemplary clearinghouse interconnections to a UMTS carrier, where the clearinghouse acts as a 3GPP defined GMLC and LCS Client in multiple wireless networks.

FIG. 3C shows exemplary clearinghouse interconnections to a CDMA2000 carrier, where the clearinghouse acts as both a 3GPP2-defined Network LCS Client and an External LCS Client in multiple wireless networks.

FIG. 3D shows the clearinghouse implemented in a Generic Access Network (GAN).

FIG. 4 shows steps employed for user service provisioning using the clearinghouse via a 3rd party storefront.

FIG. 5 shows steps employed for execution of a subscriber-specific location based service (LBS), in this example a mobile application used to locate another mobile device.

FIG. 6 depicts the procedure for the clearinghouse to supply anonymous location information to a 3rd party based on user privacy settings and the requested area.

FIG. 7 depicts a clearinghouse supplying access to service subscribed mobile location based on user privacy settings and a clearinghouse LBS data auction application.

FIG. 8 illustrates a clearinghouse used as a datamining facility into allowed and/or anonymous location information stored by the clearinghouse.

### DETAILED DESCRIPTION

Wireless subscribers currently are limited by radio access technology, wireless location technology, and wireless carrier implementation of location-based services. In a notable example, wireless subscribers roaming from one operator's geographic coverage area may not be able to access location-based services available in the subscriber's home area or home carrier. This issue is compounded by the implementation of multiple access techniques (such as dual mode WiFi and GSM or CDMA mobile phones) and mobile-virtual-network-operators (MVNOs) with targeted subscriber service offerings. The inventive embodiments described herein can be used to provide wireless subscribers with access to the high quality location-based services experience while at the same time providing such wireless subscribers a uniform level of privacy and security.

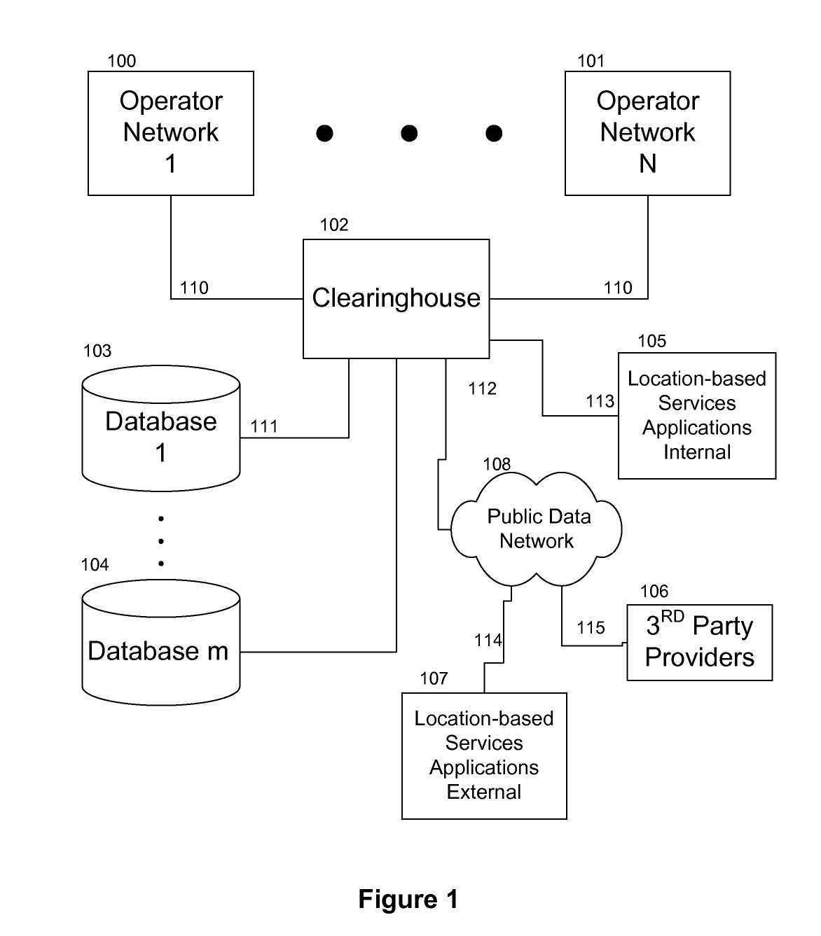

Referring to FIG. 1, in an exemplary embodiment, the wireless carriers' networks (100 and 101) may be bridged by a Clearinghouse (102). This Clearinghouse (102) takes the form of a high-capacity, high performance cluster of servers. These servers provide the processing capabilities required to interface to the various wireless carriers, manage database(s) (103, 104), prioritize and queue incoming data requests and outgoing locations, location-specific data or location services. In FIG. 1, an example of the Clearinghouse components and interconnections are schematically shown. In this case, multiple wireless (100) and wireline data networks (101) may be served by a single Clearinghouse (102); the Clearinghouse connects with the operators (100, 101) via packet data network connections (110) either dedicated or virtual. In this example, long term storage databases (103, 104) of user records and data may be stored externally to the Clearinghouse and may be connected by secure packet data links (111), but these databases (103, 104) could be stored internal to the Clearinghouse (102) and the data links (111) implemented as LANs or internal buses in the Clearinghouse (102) server cluster. The Clearinghouse server(s) may be implemented as a redundant cluster of high availability general purpose servers. This Clearinghouse server cluster may host an internal set of location-based services application software, or interconnect to dedicated LBS servers via local-area-networks. As depicted in FIG. 1, the internal LBS applications may be hosted on an external set of servers (105) and interconnected to the Clearinghouse by long-haul packet data connections (113). The Clearinghouse (102) can also connect to a public data network (108) via secure, encrypted channels (114, 115) to externally hosted LBS applications (107) run on non-clearinghouse-controlled but Clearinghouse-supervised external servers. Additional 3rd party providers (106) of services and data such as local maps, point-of-interest databases, traffic information, scheduled events, and weather conditions, for example, may be accessible by the Clearinghouse (102) and internally hosted LBS application (105) via secure packet data links (115, 113) connected and access controlled by the Clearinghouse (102) using the public data network (108) or a private packet network connection (not shown).

In the illustrative embodiment of FIG. 1, the multiple Wireless Carriers (100, 101) may be connected to the Clearinghouse (102) via digital communications links (110). The communications links (110) carry both location data and subscriber related data between the Clearinghouse (102) and the wireless carrier networks (100, 101) and include a number of physical and logical links. For instance, the location data, in the form of requests or responses may be carried on a standardized interface such as the 3GPP defined “Lr” interface or the OMA defined “Le” or Mobile Location Protocol (MLP) interface. The GSM-MAP “Lg” (MSC-to-GMLC) interface and the location-related Intelligent Networking CAMEL (Customized Application for Mobile network Enhanced Logic) interface “Lc” (GMLC-to-gsmSCF) may also be present in certain implementations that use or support Operator Specific Services (OSS) using intelligent networking capabilities.

Presence information may be carried on the communications link (110) over interfaces such as the Parlay X presence API or similar interface. Billing information may be transported on a separate logical or physical channel. Provisioning links between the Wireless Carrier networks (100, 101) and the Clearinghouse (102) may also be supported allowing for uploading of subscriber privacy and preferences profile information. The Clearinghouse (102) ability to add subscribers from external applications (107) may be important for growing the public's access to wireless location services.

The Clearinghouse servers (102) may be connected to multiple databases (103, 104) (internal or external to the server cluster) via high-speed data connections implemented as internal busses to the server, location-area-networks (LANs) or wide-area-networks where geographical redundancy for data is required. The databases (103, 104) are used to contain both static and dynamic data concerning subscriber preferences, subscriber demographics, time-indexed subscriber historical location as well as geographical information such as points-of-interest, maps, dynamic border as well as information on time-sensitive events such as road traffic patterns or event (such as football games, political rallies, baseball games, concerts, fireworks displays, etc.).

The Clearinghouse servers (102) may be connected to internally hosted location-based service applications and/or servers (105) via high-speed data connections (113) implemented as internal busses to the server, location-area-networks (LANs) or wide-area-networks where geographical redundancy or geographic deployments are used. This suite of LBS applications allow the Clearinghouse servers (102) to supply the wireless subscriber a common service experience as well as allowing wireless carriers the ability to offer subscribers a low-cost, low-infrastructure suite of LBS applications. The LBS servers (105) will also contain download facilities allowing subscribers to upload applications to their handsets and mobile devices. Additionally the internally hosted location-based service applications and/or servers (105) may connect with best-in-class 3rd party providers (106) of wireless applications over data connections (113) allowing the internal suite of applications access to outside data or for applications to hosted outside the Clearinghouse cluster. These 3rd party providers (106) may also include providers of communications connectivity external to the Clearinghouse which could include world-wide-web (WWW), Wireless Application Protocol (WAP), Short-Message-Service (SMS), and/or Multimedia Message Service (MMS). These 3rd party providers (106) may also be used to supply mobile device application software or clients based on the Java 2 Micro Edition (J2ME), Binary Runtime Environment for Wireless (BREW), Windows Mobile, and Symbian platforms.

The Clearinghouse servers (102) are connected to external location-based service applications and/or servers (107) via high-speed data connections (113) implemented as location-area-networks (LANs) or wide-area-networks (WANs) over the internet or intranet (108). Externally hosted location based services applications can use the Clearinghouse (102) to obtain subscriber location, obtain subscriber location specific data, or post location-related information to the wireless subscriber via the Clearinghouse (102) under the control of the stored subscriber privacy and preferences settings.

The external location-based service applications and/or servers (107) may also be allowed to provision new services for a subscriber under strict control of the wireless operator as enforced by the Clearinghouse held privacy and preferences policies. An example of this provisioning is when an MNVO uses the Clearinghouse (102) for back-office operations such as adding a locatable mobile device to an existing carrier subscriber account.

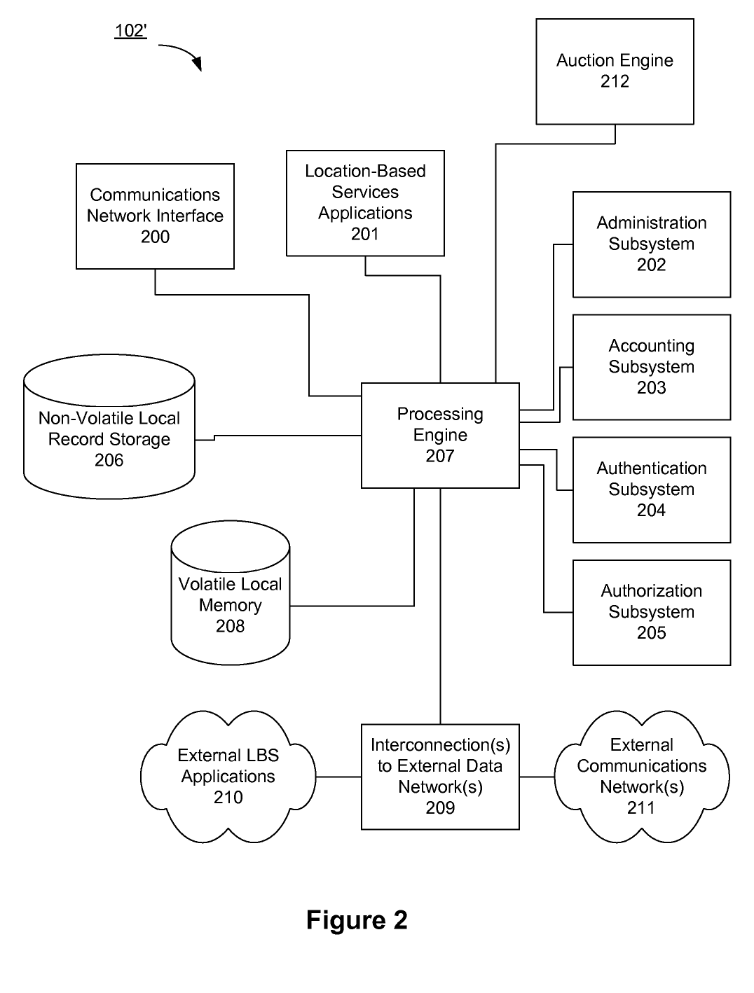

FIG. 2 depicts the internal functional components of an exemplary Clearinghouse implementation (102′), including a Communications Network Interface (200), Location-Based Services Application(s) (201), Administration Subsystem (202), Accounting Subsystem (203), Authentication Subsystem (204), Authorization Subsystem (205), Non-Volatile Local Record Storage (206), Processing Engine (207), and Volatile Local Memory (208). As shown, the Clearinghouse implementation (102′) may be coupled via an Interconnections Subsystem (209) to External LBS Application(s) (210) and External Communications Network(s) (211). In this example embodiment, an instantiation of the Communications Network Interface (200) exists for each interconnected communications network. The Communications Network Interface (200) performs communications link management functions such as link load balancing, redundancy control, congestion control and other communications link management functions. The Communications Network Interface (200) provides link level security with heartbeat, periodic re-authentication and challenge-responses. The Communications Network Interface (200) can also provide prioritization based on quality or priority of service for individual requests. The Processing Engine (207) is the core computing power of the Clearinghouse (102) providing internal message flow management, prioritization, and queuing between the Clearinghouse (102) subsystems as well as general purpose computing functions. The Clearinghouse may support a suite of internally hosted Location-based services (201) that either share the Processing Engine (207) capabilities or may be hosted on a network interconnected server platform.

Each of the subsystems/components depicted in FIG. 2 are summarized below:

Administration Subsystem 202: The Administration Subsystem (202) maintains individual user records and services subscription elections. The Administration Subsystem allows for arbitrary groupings of users to form services classes. User subscriber records may include ownership; passwords/ciphers; account permissions; user mobile device capabilities; mobile device make, model, and manufacturer; access credentials; and static or dynamic routing information. In the case where the user mobile device is a registered device under a wireless communication provider's network, the administration Subsystem (202) preferably maintains all relevant parameters allowing for mobile user access of the wireless communication provider's network.

Accounting Subsystem 203: The Accounting Subsystem 203 handles basic accounting functions including maintaining access records, access times, and location applications accessing the Client location allowing for charging for individual mobile devices, applications run on mobile devices, and individual LBS services. The Accounting Subsystem also preferably records and tracks the cost of each access by the wireless communications network provider and the wireless location network provider. Costs may be recorded for each access and location. The Clearinghouse (102) can be set with a rules-based system for the minimization of access charges via network and location system preference selection.

Authentication Subsystem 204: The main function of the Authentication Subsystem 204 is to provide the Clearinghouse (102) with the real-time authentication factors needed by the authentication and ciphering processes used within the internal, radio or external network for user access, user device access, data transmission and LBS-application access. The purpose of the authentication process is to protect the user, radio, and internal Clearinghouse (102) network by denying access by unauthorized users, mobile devices, mobile applications or external location-applications to the radio or Clearinghouse (102) network and to ensure that confidentiality is maintained during transport over a wireless carrier's network and wireline networks.

Authorization Subsystem 205: The Authorization Subsystem (205) uses data from the Administration and Authentication Subsystems to enforce access controls upon mobile user devices, mobile-based applications, and external Location-based applications. The access controls implemented may be those specified in Internet Engineering Task Force (IETF) Request for Comment RFC-3693, “Geopriv Requirements,” the Liberty Alliance's Identity Service Interface Specifications (ID-SIS) for Geo-location, and the Open Mobile Alliance's (OMA) Public Key Infrastructure. The Authorization Subsystem may also obtain location data for a user's mobile device before allowing or preventing access to a particular service or Location-based application. Authorization may also be calendar-based or clock-based dependent on the services described in the user profile record resident in the Administration Subsystem (202). The Authorization Subsystem (205) may also govern connections to external billing system and networks, denying connections to those networks that are not authorized or cannot be authenticated.

Non-Volatile Local Record Storage 206: The Non-Volatile Local Record Storage 206 of the Clearinghouse (102) is primarily used by the Administration, Accounting, and Authentication Subsystems to store user profile records, ciphering keys, network-based location-technology deployments, localized location technology information, and wireless carrier information.

Processing Engine 207: The Processing Engine Subsystem 207 may be a general purpose computer or a cluster of such computers. The Processing Engine 207 manages Clearinghouse resources, provides generic processing power, manages resource schedules, and routes data between subsystems.

Volatile Local Memory 208: The Clearinghouse 102 has a Volatile Local Memory store 208 composed of multi-port memory to allow the Clearinghouse (102) to scale with multiple, redundant processors.

Interconnection(s) to External Data Network(s) 209: The interconnection to External Data networks is designed to handle conversion of the mobile and or Clearinghouse data stream to external LBS applications. The interconnection to External Data networks is also a firewall to prevent unauthorized access as described in the Internet Engineering Task Force (IETF) Request for Comment RFC-3694, “Threat Analysis of the Geopriv Protocol.” Multiple access points resident in the Interconnection to External Data Networks Subsystem 210 allow for redundancy and reconfiguration in the case of a denial-of-service or loss of service event. Examples of interconnection protocols supported by the Clearinghouse (102) include the Open Mobile Alliance (OMA) Mobile-Location-Protocol (MLP) and the Parlay X specification for web services; Part 9: Terminal Location as Open Service Access (OSA); Parlay X web services; Part 9: Terminal location (also standardized as 3GPP TS 29.199-09).

External Billing Network(s) 210: Authorized External Data/Billing Networks and billing mediation systems may access the Clearinghouse's Accounting Subsystem database through this subsystem. Records may also be sent periodically via a pre-arranged interface. Examples of the diverse billing interconnections provided by the external billing network subsystem 210 may include the OMA's Billing Framework 1.0 specification and the Parlay X—Payment Web service.

External Communications Network(s) 211: External Communications Networks refer to those networks, both public and private, used by the Clearinghouse (102) to communicate with location-based applications not resident on the Clearinghouse (102) or on the user device.

Auction Engine 211: The Auction Engine (211) may be implemented as a software application designed to allow re-selling of a mobile user's position to interested bidders. As currently envisioned, the location of Clearinghouse registered mobile device can be reused for multiple personalized and anonymous location applications, minimizing cost of location. In this inventive concept, the Clearinghouse could auction opt-in subscribers to advertisers. Auctions could include willing subscribers at or around a particular site, subscribers who frequent a site, or the demographic profile of the subscriber.

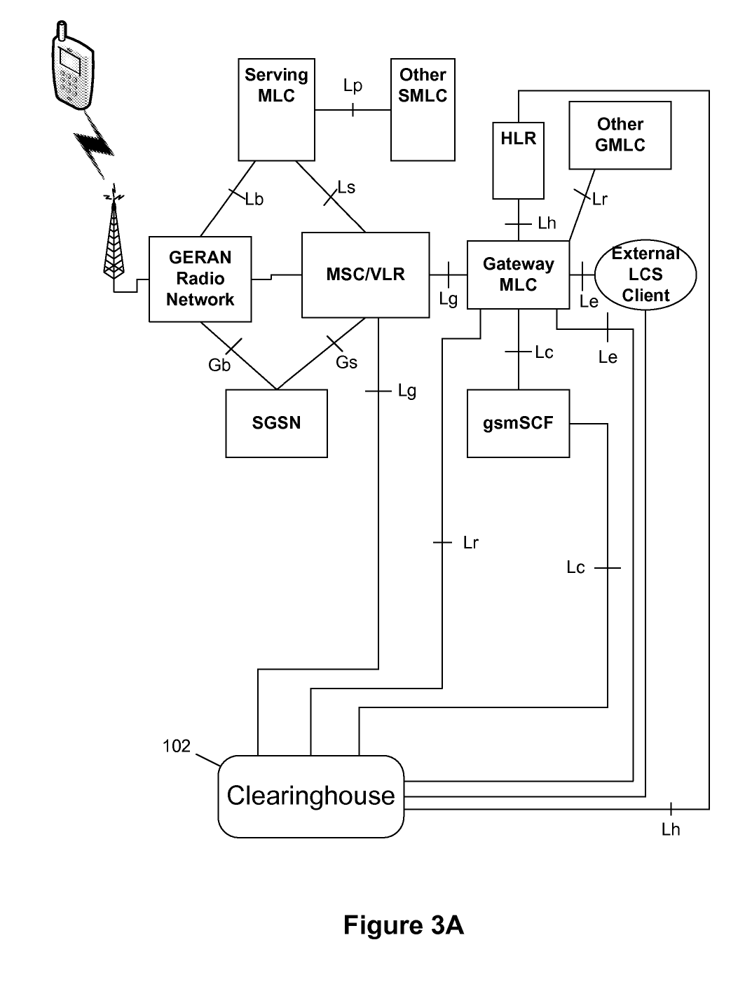

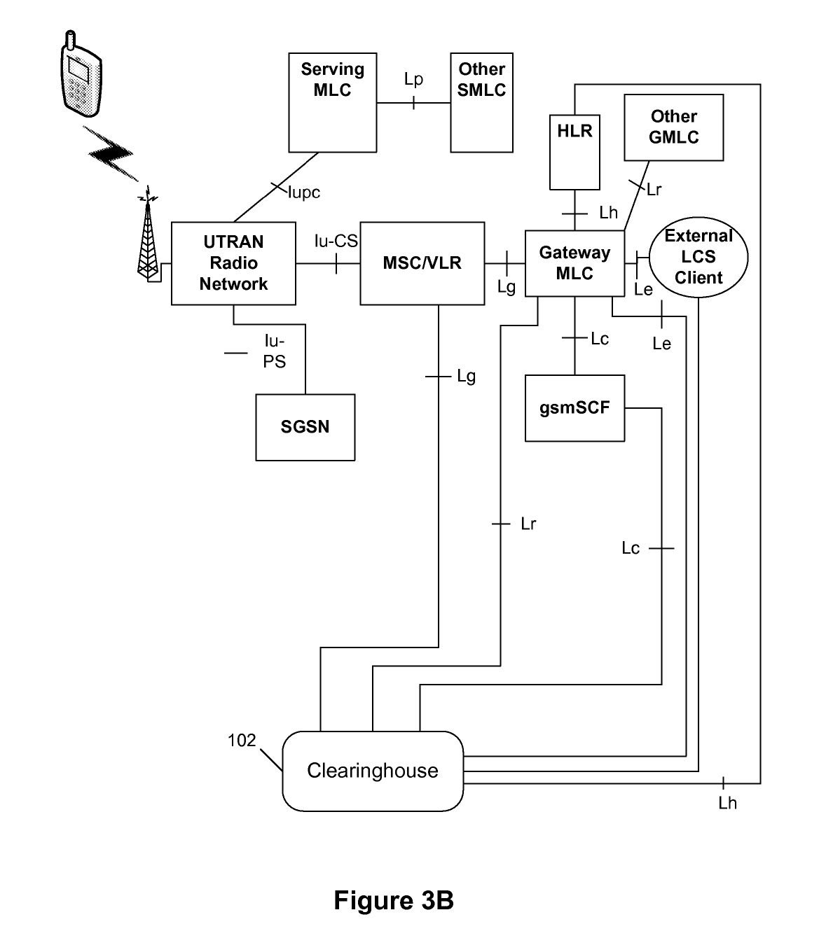

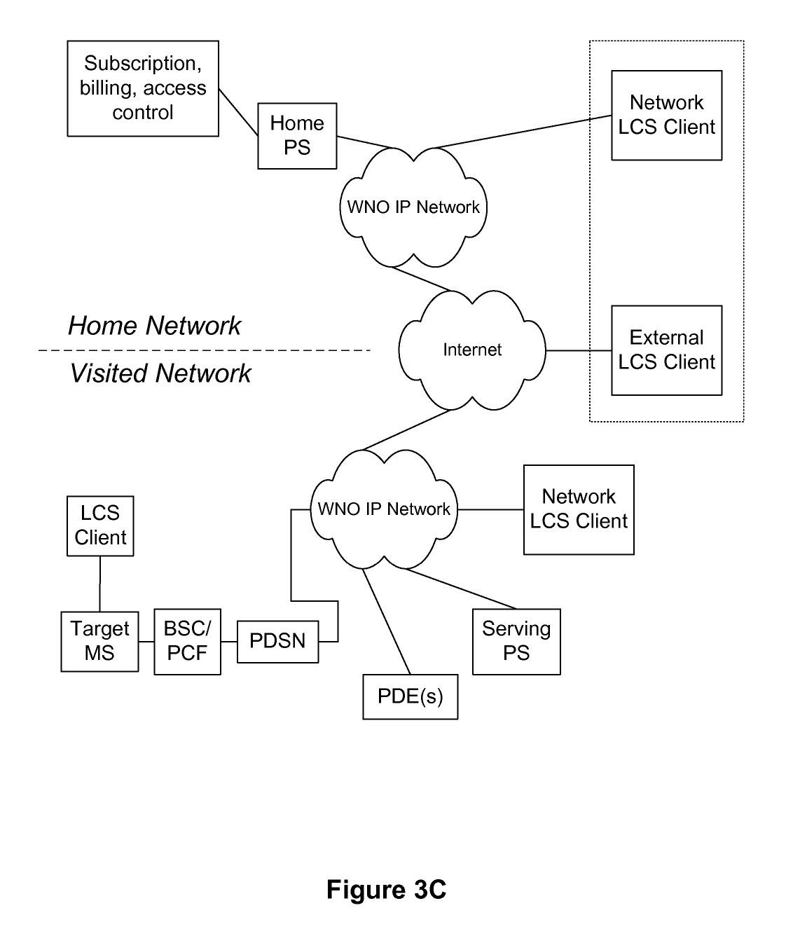

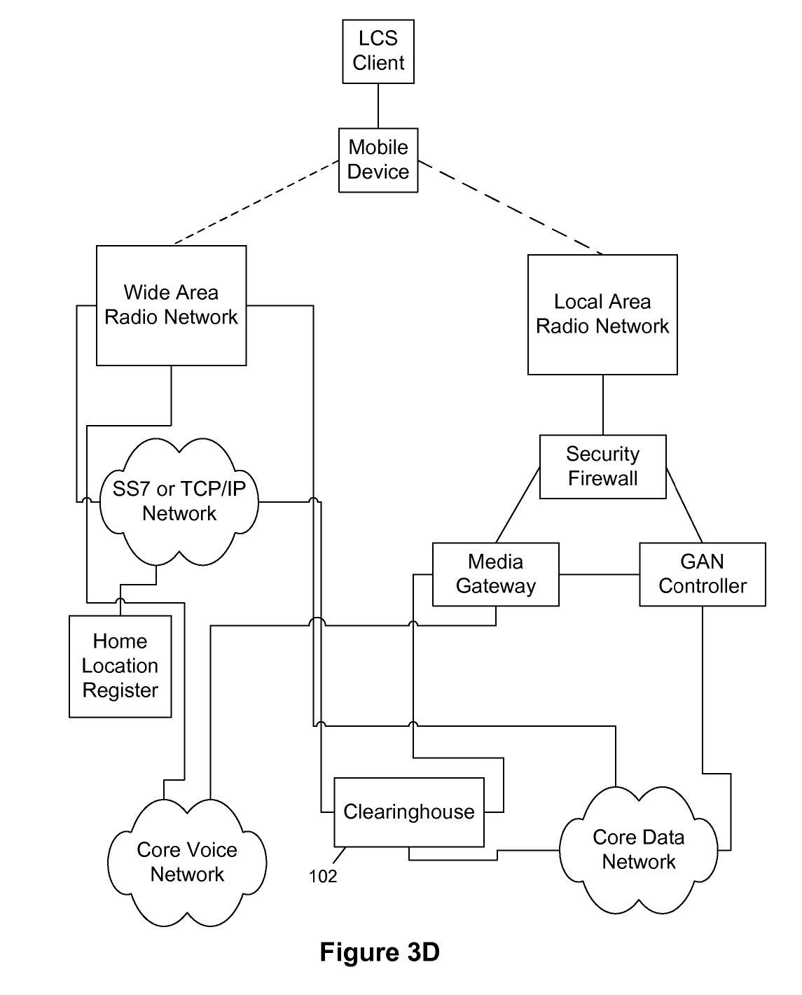

FIG. 3A illustrates how the Clearinghouse 102 may be implemented in a GSM network. Options for integrating the Clearinghouse into the GSM network as a location services client, a Gateway Mobile Location Center (GMLC) or as an Intelligent Networking Client are shown. In addition to the standardized, ‘control plane’ interfaces and nodes shown in FIG. 3A, the Clearinghouse can create a data connection to the wireless device via the Gateway GPRS Support Node (GGSN) or, if allowed, directly to the Serving GPRS Support Node (SGSN). This data connection allows for importation of offered software downloads from the Clearinghouse or Clearinghouse associated 3rd parties and communication between the mobile devices hosted software and the Clearinghouse's associated servers. These associated servers may include location-servers such as those hosting user-plane A-GPS (assisted GPS), EOTD (enhanced observed time difference of arrival) or OTDOA (observed TDOA) location applications or generic applications such as mapping, point-of-interest find-the-nearest, or a friend finder application.

The Clearinghouse (102) acting as an LCS client allows the Clearinghouse to communicate location requests and replies through the wireless carrier's correctly provisioned GMLC. Using the “Le”, LCS client-to-GMLC interface as standardized by the Open Mobile Alliance (OMA) as the Mobile Location Protocol (MLP) interface, the Clearinghouse can request immediate, delay tolerant and periodic sequences of location for subscribers on the wireless network. The LCS client cannot currently (via the OMA MLP version 3.1) provision subscribers on the GMLC nor can the LCS client set subscriber privacy and security settings. When the Clearinghouse is acting as a LCS Client, additional interfaces and APIs will be required for these back-office functions.

If the wireless carrier allows, the Clearinghouse can act as the sole or as an additional GMLC in the carrier's network. Acting as a GMLC in the GSM Network Subsystem (NSS) or core network allows the Clearinghouse to maintain local privacy and security settings for Clearinghouse provisioned subscribers and roamers. The GMLC direct connections to the HLR (Lh) and MSC (Lg) allow for efficient low-accuracy location, presence, availability, and subscriber status (on-call, idle, etc.). If the carrier network has serving Mobile Location Center(s) (SMLC) deployed, the Clearinghouse GMLC can access high-accuracy location via standardized messaging. If the Clearinghouse is the sole location services GMLC, the Clearinghouse can efficiently schedule GMLC and SMLC location resources, maximizing the SMLC usage by prioritizing and scheduling of location requests. If multiple SMLC-based location technologies are deployed, the Clearinghouse GMLC can also efficiently prioritize and schedule these SMLC resources based on location precision and location latency.

FIG. 3A illustrates how the Clearinghouse 102 may be implemented in a UMTS network. Options for integrating the Clearinghouse into the UMTS network as a location services client, a Gateway Mobile Location Center (GMLC) or as an Intelligent Networking Client are shown. Since the UMTS core network is based on the GSM/GPRS core network, the same capabilities exist for location-based services. The ‘user plane’ services utilizing the Clearinghouse to mobile device data link as also replicable in a UMTS network.

FIG. 3C schematically depicts a representative configuration of the major components of a wireless communications system based on the ANSI and 3GPP2 standards. As shown the packet-based architecture allows the Clearinghouse to be implemented as an external LCS client or as a trusted Network LCS client. The ‘user plane’ services utilizing the Clearinghouse to mobile device data link as also replicable in a CDMA or CDMA2000 network.

FIG. 3D schematically depicts a representative configuration of the major components of a wireless communications system based on 3GPP standards (3GPP Release 6. and TS 44.318) for cross-radio technology called Generic Access networks (GAN). GAN allows communications service delivery to subscriber devices both over wide-area cellular radio networks, but also local area networks. Since the inventive Clearinghouse uses packet-based ‘user plane’ services of the mobile network, the Clearinghouse will function in a GAN or UWA (Unlicensed Wireless Access). The Clearinghouse connects via the GAN controller (GANC) which currently provides cell-ID level location information or connects via the GAN GSN to connect to location technology resident on the mobile device. The ‘user plane’ services utilizing the Clearinghouse to mobile device data link as also replicable in a GAN network. An example of a GAN network would be a hybrid system using WiFi (IEEE 802.11) for localized coverage and a cellular network such as GSM or CDMA for wide-area coverage and service delivery.

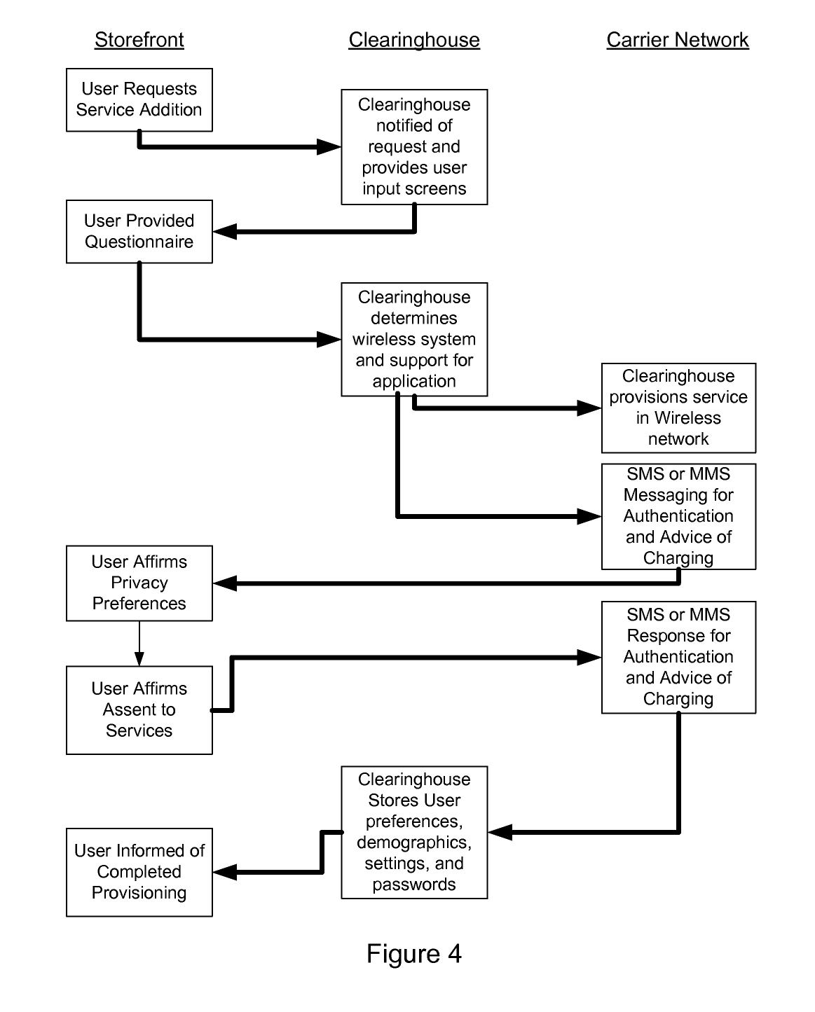

FIG. 4 depicts exemplary operations of the Clearinghouse to provision subscribers within the Clearinghouse and the wireless operator. If the Clearinghouse is allowed by the carrier to operate as a GMLC, then provisioning will occur only within the Clearinghouse using the carrier's SMS or MMS facilities for out-of-band communication and verification with the wireless subscriber.

FIG. 4 Provisioning Example: The clearinghouse may be used to provision a subscriber from a 3rd party. FIG. 4 provides an illustrative method for provisioning of a clearinghouse user, also called a subscriber, to clearinghouse services. In this figure, provisioning takes place via a storefront provided by a 3rd party retailer or application provider using the clearinghouse to store user details and interface with the wireless carrier or operator. The first step of provisioning services for a new user or a new service for an existing user starts with the user requesting said service. This request comes to the clearinghouse via the 3rd party application, generically called a storefront. This storefront application can be entered by the user or as a back-office function by the 3rd party retailer. An important aspect of the provisioning method is the entering of user identification data allowing the clearinghouse to ascertain if the user is already provisioned on the clearinghouse. The identification is processed by the clearinghouse and a questionnaire is composed by the clearinghouse to collect the necessary data for service provisioning. This data includes demographic information, security and privacy preferences as well as permissions for accessing of the user's wireless carrier. From the questionnaire, the clearinghouse determines the user's wireless network and support for the requested application or service to be provisioned. The clearinghouse interacts with the wireless network to provision the service and uses the wireless network's messaging facilities to complete the transaction outside the storefront. By using the wireless network and the mobile device's messaging capabilities, both a greater level of security and service can be obtained since the user is preferably required to have the device in-hand for provisioning. Using the wireless messaging capability, the user is delivered a summary of the selected security, privacy, and billing preferences. Using the wireless messaging facility, the user affirms the selection on which the clearinghouse completes processing and storage before informing the user of success of provisioning.

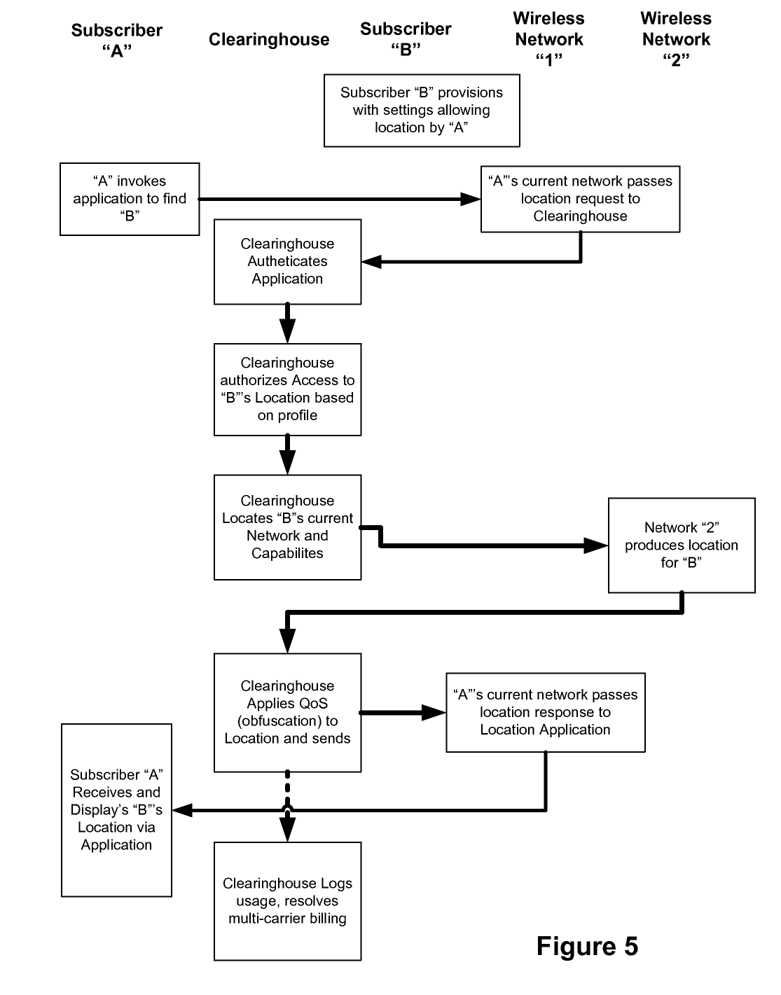

FIG. 5 shows the operations of the Clearinghouse to facilitate and deliver cross-carrier service while maintaining subscriber security and privacy. Using the clearinghouse, subscriber-specific services can be granted on the basis of pseudonyms or temporary identifiers as well as permanent identifiers linked to permanent wireless network identifiers such as mobile ID, phone number, email address and the like. In this case, the clearinghouse acts to translate between the permanent and pseudonymous, and in some cases temporary, identifiers. FIG. 5 provides an illustrative method for providing subscriber specific location based services. In this example, a clearinghouse user locates another clearinghouse user under the clearinghouse security and privacy regime on a different wireless network. When a subscriber, called “A” in this example, attempts to locate another subscriber, called “B” in this example, using a mobile device based software application, the clearinghouse is used to provide security, privacy, routing and any inter-carrier messaging. In this example the clearinghouse also obfuscates the location produced by Network 2's geolocation capabilities according to Subscriber B's security and privacy profile for location accuracy before sending the location to the requesting user, Subscriber A. The clearinghouse, as shown in FIG. 5, also can be used to perform billing operations as established with the wireless network operators, especially in the case of cross-carrier billing resolution.

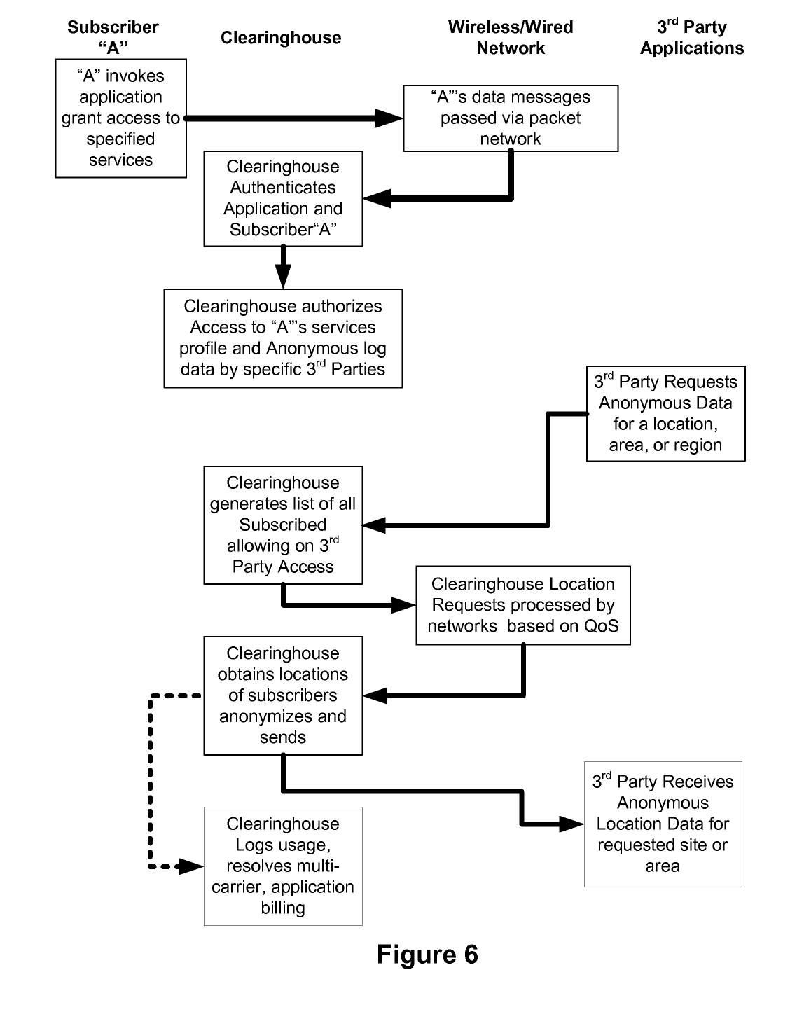

FIG. 6 shows the operations of the Clearinghouse to facilitate and deliver carrier independent service while maintaining subscriber security, privacy and anonymity. The clearinghouse can be used to provide anonymous location data to 3rd parties as allowed by subscribers. Such data can be resold in relation to a location, area or region, or based on the demographic profile of the subscriber if allowed. In the illustrative example depicted in FIG. 6, the election to allow anonymous location data to be provided is done at service provisioning or at another stage prior to anonymous location data collection. In the example, the grant for anonymous location data is preformed at the clearinghouse using a data connection to the subscriber's mobile device, although back-office or off-line methods may also be used. In the illustrative example shown in FIG. 6, the 3rd party requests anonymous location data associated with a location, area or region of interest. This request will also include a specific time and duration for the anonymous location data either in the past or the future. Alternatively, an accumulation point may be used to terminate the collection once a specified number of locations have been reached. In this example, the data collection is immediate for a set duration. During the collection time, the clearinghouse collects all locations from subscribers granting anonymous location data. This collection may be passive or active. With passive polling, the clearinghouse relies on location-of-opportunity where location requests by users directed to other applications are re-used by collecting them and then making them anonymous. With active polling, likely users are queried by the clearinghouse using the wireless network's location polling methods (for example the AnyTimeInterrogation (ATI) method described in technical standards specifications of 3GPP). Likely users are those users who grant anonymous access and are likely based on historical behavior to be in or near the area-of-interest. Once the data is collected, the location data is pre-processed to fulfill both the minimum accuracy required by the requesting application and the accuracy allowed by the various users involved. Next the location data is anonymized and delivered. As a final step, any billing related matters are completed amongst the 3rd party application, clearinghouse, and involved wireless networks.

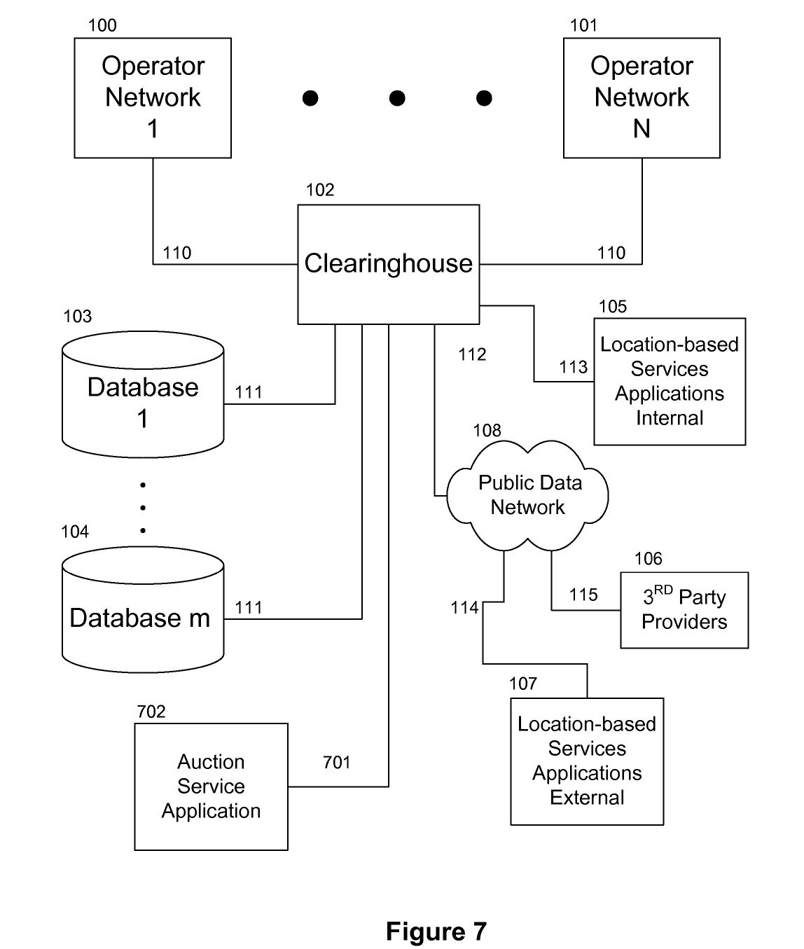

FIG. 7 depicts the interconnections of the Clearinghouse with the added auction services application (701), shown here as external to the Clearinghouse (102) but capable of being hosted internal to the Clearinghouse server cluster. In this case, the auction is being used for anonymous granting of advertising rights to the Clearinghouse registered mobile devices.

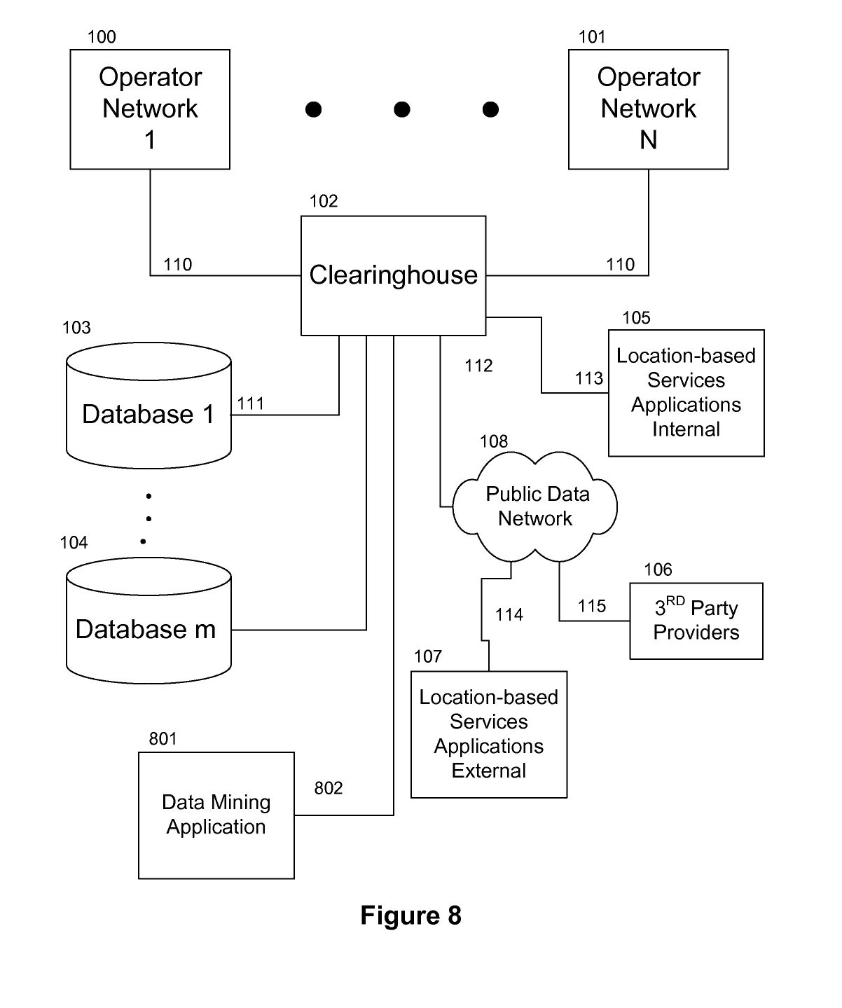

FIG. 8 depicts the interconnections of the Clearinghouse with the added datamining application (801), shown here as external to the Clearinghouse (102) but capable of being hosted internal to the Clearinghouse server cluster. In this case, the datamining is being used for anonymous mining of the Clearinghouse registered mobile device's historical locations and activities.

An Illustrative Example:

The following description explains how the Clearinghouse may be employed to support an LBS application for social networking.

As an illustrative example of the Clearinghouse support for an external LBS application, a social networking LBS application called “friend finder” is deployed using the Clearinghouse for provisioning with multiple carriers. The subscriber would discover the LBS application via a social networking web application. An online questionnaire would be the primary method to establish that the subscriber's carrier uses the Clearinghouse and thus the “friend finder” application is available. Other methods such as interactive voice response systems or human operators are also possible.

Since in some cases, the subscriber may even be unaware of the actual wireless operator's network he or she is using, the Clearinghouse may poll the connected wireless carriers to discover the subscriber's affiliation. Since the subscriber may be unaware of the location capabilities or even the make and model of their mobile device, this information may also be discovered by polling the connected wireless carriers.

The Clearinghouse may optionally use SMS or MMS messaging to establish communication with the subscriber's mobile device. The subscriber would confirm receipt back to the Clearinghouse, confirming the subscriber device and entered settings. Notification of required software or configuration downloads to enable the desired application would also be supplied via SMS or MMS messaging.

In this illustrative example, billing and charging would be established via the provisioning application such as a WWW site with credit card entry. The Clearinghouse could also, with the appropriate contractual agreements in place, add the newly provisioned service to the subscriber's wireless bill via the billing system interconnection the Clearinghouse can provide.

As part of the provisioning process through the external LBS application example, the user agreement and privacy settings would be transmitted by the Clearinghouse through the external LBS application for acceptance by the wireless subscriber. Confirmation of the acceptance and advice-of-changing could be managed via SMS or MMS requiring that the location application user be in physical possession of the phone during the provisioning process. A temporary personal identifier will be generated during the provisioning session. This identifier will be delivered to the subscriber via the acceptance SMS and must be entered into the provisioning application to finalize the provisioning process. Once provisioning is complete, the user may be asked to create a permanent, personalized password and the user safety, security and privacy settings reviewed.

Errors encountered during the registration and provisioning process are in this example handled by the external LBS application, with the Clearinghouse acting as a secure storage node for user information, wireless subscriber information, and passwords or security settings.

Using the “friend finder” LBS application as an illustrative example, the Clearinghouse would provide core functionality to enable the application regardless of the application being internally or externally hosted. The Clearinghouse would hold the ‘buddy’ list for each provisioned subscriber, it would hold time-of-day location access information and each “buddy's” location access and accuracy rights for each ‘buddy’ or ‘buddy group’, the Clearinghouse would hold time-indexed historical location allowing for reduction in locations requested from the wireless carrier by caching and redistributing the most recent location from the ‘friend finder’ LBS application or any other LBS application. When a location update is required or requested, the Clearinghouse would determine the appropriate carrier based on cached data or polling for presence and availability from the designated carrier for that user or the most likely subset of carriers given the cached or roaming information.

Once the external LBS application has been fully registered and provisioned, and any client software or configurations on the mobile device have been installed, the user can control the application and application settings via the mobile device communications with the Clearinghouse without duplication at the external LBS application server or in the carrier network. Settings include resetting to default behavior and settings or user customization of settings. Settings include maintenance of the ‘buddy’ list members, location accuracy allowed for each member or group, location based messaging including advertising, times when location is allowed, times when location-based messaging is allowed, default handling of invitations from other users, message delivery format (voice, text, etc) and language settings.

With the Clearinghouse handling all data storage, transaction management, obtaining of location, and interfacing to the desired messaging means, a wireless carrier or external services enterprise can easily create a location-based service application or suite of applications with minimum outlay of infrastructure. The subscriber also benefits from the end-to-end automated solution for registration, provisioning, and privacy security across multiple carrier and LBS applications allowed by the Clearinghouse concept.

Additional Embodiments

Location Cache/Reuse for multiple services: Locations of subscribers can be reused for multiple personalized and anonymous location applications, thus minimizing costs associated with location services. A system and method for cost-reduction of location based services by using a location Clearinghouse (3rd party) to transact a location on a subscriber and then reuse the location to: 1) service any outstanding requests for that subscriber, 2) aggregate for anonymous location applications, and 3) service any 4th party push applications allowed under the subscriber preferences.

Push Ad Delivery to Anonymous Subscriber: Again, locations of subscribers can be reused for multiple personalized and anonymous location applications, and this can minimize costs. In this concept the subscriber is anonymous to the advertiser, known only by demographic, current location, time-of-day, etc. Under control of the subscriber profile, targeted Adverts could be delivered to subscriber. These ads could include links to opt-in, opt-out page or the advertiser's web site.

Normalization Processing: In this embodiment, the location Clearinghouse serves to abstract and standardize subscriber profiles, subscriber privacy settings, and the format of shared cross-carrier, cross-technology data (such as location).

Conclusion

The true scope the present invention is not limited to the presently preferred embodiments disclosed herein. For example, the foregoing disclosure of presently preferred embodiments uses explanatory terms, including capitalized terms such as Clearinghouse, Communications Network Interface, Location-Based Services Application, Administration Subsystem, Accounting Subsystem, Authentication Subsystem, Authorization Subsystem, Non-Volatile Local Record Storage, Processing Engine, Volatile Local Memory, Interconnections Subsystem, External LBS Application, External Communications Network, and the like, which should by no means be construed so as to limit the scope of protection of the following claims, or to otherwise imply that the inventive aspects of the illustrative embodiments are limited to the particular methods and apparatus disclosed. Moreover, as will be understood by those skilled in the art, many of the inventive aspects disclosed herein may be applied using future wireless protocols, networks, and location techniques. In many cases, the place of implementation (i.e., the functional element) described herein is merely a designer's preference and not a hard requirement. Accordingly, except as they may be expressly so limited, the scope of protection of the following claims is not intended to be limited to the specific embodiments described above.

What is claimed:

1. A system configured to operate as a clearinghouse for provisioning subscriber-specific information relating to subscribers of different wireless networks, comprising:
a processing engine configured to receive subscriber-specific information from a plurality of subscribers of different wireless networks, and to provide internal message flow management, prioritization, and queuing between subsystems;
a communications network interface operatively coupled to said processing engine, wherein the communications network interface is configured to perform communications link management functions including link load balancing, redundancy control and congestion control;
at least one location-based services application operatively coupled to said processing engine;
an administration subsystem, operatively coupled to said processing engine, configured to maintain user records and services subscription elections;
non-volatile local record storage operatively coupled to said processing engine, wherein said non-volatile local record storage is used to store user profile records, ciphering keys, network-based location-technology deployments, localized location technology information, and wireless carrier information;
volatile local memory operatively coupled to said processing engine, wherein the volatile local memory store comprises multi-port memory to allow the system to scale with multiple, redundant processors; and
an interconnections subsystem operatively coupled to said processing engine, wherein the interconnections subsystem is configured to couple the system to external location-based services application and external communications networks.

2. A system as recited in claim 1, further comprising an auction engine operatively coupled to said processing engine, wherein the auction engine comprises a software application configured to allow re-selling of a mobile user's position to interested bidders.

3. A system as recited in claim 1, further comprising an accounting subsystem operatively coupled to said processing engine, wherein said accounting subsystem is configured to maintain records allowing for charging for individual mobile devices, applications run on mobile devices, and individual services.

4. A system as recited in claim 1, further comprising an authentication subsystem operatively coupled to said processing engine, wherein said authentication subsystem provides real-time authentication factors employed by authentication and ciphering processes.

5. A system as recited in claim 1, further comprising an authorization subsystem operatively coupled to said processing engine, wherein said authorization subsystem is configured to use data from administration and authentication subsystems to enforce access controls upon mobile user devices, mobile-based applications, and external applications.

6. A system as recited in claim 5, wherein said authorization subsystem is further configured to obtain location data for a user's mobile device before allowing access to a particular service or location-based application.

7. A system as recited in claim 1, wherein said administration subsystem is configured to allow for arbitrary groupings of users to form services classes.

8. A system as recited in claim 1, wherein the user records maintained by said administration subsystem include ownership; passwords/ciphers; account permissions; user mobile device capabilities; mobile device make, model, and manufacturer; access credentials; and routing information.

9. A system as recited in claim 1, wherein said communications network interface is configured to provide link level security with heartbeat, periodic re-authentication and challenge-responses, and to provide prioritization based on at least one of quality and priority of service for individual requests.

10. A system as recited in claim 1, wherein the system is configured to support a suite of internally hosted location-based services application.

11. A system as recited in claim 1, wherein said interconnections subsystem is configured to convert mobile and clearinghouse data streams to external location-based services applications, and to act as a firewall to prevent unauthorized access.

12. A method for provisioning subscriber-specific information relating to subscribers of different wireless networks, comprising:
providing a clearinghouse capable of communicating subscriber-specific information to and from a plurality of wireless networks;
communicating information about a first subscriber in a first of said wireless networks to said clearinghouse;
communicating information about a second subscriber in a second of said wireless networks to said clearinghouse; and
communicating the information about at least one of said first subscriber and said second subscriber from said clearinghouse to a recipient, wherein said recipient is one of a subscriber of at least one of said wireless networks and a wireless service application.

13. A method as recited in claim 12, further comprising communicating information from a wireless service application to one or more subscribers.

14. A method as recited in claim 12, wherein said information communicated to the recipient includes the geographic location of the first or second subscriber.

15. A method as recited in claim 12, wherein said information communicated to the recipient includes an identification of the first or second subscriber.

16. A method as recited in claim 12, wherein said wireless service application comprises a presence application that uses information regarding the presence, absence or other state of the subscriber in relation to a network.

17. A method as recited in claim 12, wherein said wireless service application comprises an availability application that uses information concerning whether a subscriber is available, and on what device, for a specified purposes.

18. A method as recited in claim 12, wherein said wireless service application comprises a location-based services (LBS) application that uses the subscriber's current location to provide location targeted information or services.

19. A method as recited in claim 18, wherein the LBS application is configured to provide location data to at least one of: advertisers, social networks, content providers, enterprises and game developers.

20. A system for provisioning subscriber-specific information relating to subscribers of different wireless networks, comprising:
means for providing a clearinghouse capable of communicating subscriber-specific information to and from a plurality of wireless networks;
means for communicating information about a first subscriber in a first of said wireless networks to said clearinghouse;
means for communicating information about a second subscriber in a second of said wireless networks to said clearinghouse; and
means for communicating the information about at least one of said first subscriber and said second subscriber from said clearinghouse to a recipient, wherein said recipient is one of a subscriber of at least one of said wireless networks and a wireless service application.

21. A system as recited in claim 20, further comprising means for communicating information from a wireless service application to one or more subscribers.

22. A system as recited in claim 20, wherein said information communicated to the recipient includes the geographic location and identification of the first or second subscriber.

23. A system as recited in claim 20, wherein said wireless service application comprises a presence application that uses information regarding the presence, absence or other state of the subscriber in relation to a network.

24. A system as recited in claim 20, wherein said wireless service application comprises an availability application that uses information concerning whether a subscriber is available, and on what device, for a specified purposes.

25. A system as recited in claim 20, wherein said wireless service application comprises a location-based services (LBS) application that uses the subscriber's current location to provide location targeted information or services, wherein the LBS application is configured to provide location data to at least one of: advertisers, social networks, content providers, enterprises and game developers.
